(19) United States
(12) Patent Application Publication
(10) Pub. No.: US 2025/0280440 A1
(43) Pub. Date: Sep. 4, 2025

(54) Packet Control for Multiple Devices

(71) Applicant: TEXAS INSTRUMENTS INCORPORATED, Dallas, TX (US)

(72) Inventors: Maxim Altshul, Kadima (IL); Yaron Alpert, Hod-Hasharon (IL); Bhargavi Nisarga, Dallas, TX (US); Inbal Farchy, Beer-Sheva (IL)

(21) Appl. No.: 18/813,029

(22) Filed: Aug. 23, 2024

Related U.S. Application Data
(60) Provisional application No. 63/559,274, filed on Feb. 29, 2024.

(51) Int. Cl. H04W 74/0816; H04B 17/318; H04J 3/06

(52) U.S. Cl. CPC H04W 74/0816; H04B 17/318; H04J 3/0658

(57) ABSTRACT

A method may include a controller device coordinating a multitude of advertising devices so that the advertising devices may have respective advertising intervals and timing offsets, thereby avoiding collision. As a result, the multitude of advertising devices may participate in a synchronized advertising train (SAT). In one example, the multitude of advertising devices are associated with a single electronic system and share an identity address, though the advertising devices may have different resolvable private addresses. A connecting (central) device may respond to advertising packets of the SAT, and each of the advertising devices may then receive the response from the connecting device, measure a signal quality of the connecting device, and provide signal quality metric data to the controller device. The controller device may then select one of the advertising devices to establish a connection with the connecting device based upon the received signal quality metric data.

### CROSS-REFERENCE TO RELATED APPLICATIONS

The present applications claims the benefit of U.S. Provisional Application 63/559,274, filed Feb. 29, 2024, the disclosure of which is hereby incorporated herein by reference.

### TECHNICAL FIELD

The present disclosure relates generally to electronic systems and methods, and, in some embodiments, to packet control for multiple devices.

### BACKGROUND

Bluetooth (BT) Classic and Bluetooth Low Energy (BLE) are examples of communication protocol standards that facilitate wireless data transmission over a radio link. Various applications include a BLE master or central device (a “central”) that maintains wireless communication links with multiple BLE slave or peripheral devices (each a “peripheral”).

### SUMMARY

In some embodiments, a controller of a system causes transmission of a train of advertisement packets by respective devices of the system. By controlling the timing of the transmissions of the train of advertisement packets, some embodiments advantageously avoid collisions between the advertisement packets (e.g., even though the advertisement packets are transmitted by different devices).

In some embodiments, the devices of the system listen to a response from the train advertisement packet irrespective of whether the response is addressed to the listening device. By allowing devices to listen for and process packets not addressed to the listening device, some embodiments advantageously allow for the determination of a quality metric associated with each of the listening devices, which may advantageously allow for the selection of an optimal device based on the quality metric for further communication.

In some embodiments, the system is a vehicle. In embodiments in which the system is a vehicle, some embodiments may advantageously allow the connecting device to establish communication with the controller via an optimal device of the system while reducing or minimizing the connection time.

In some embodiments, each of the devices of the system has a unique resolvable private address (RPA), each of which resolves to the same address of the system, which may advantageously allow the connecting device to communicate with the system (e.g., with the controller of the system) without concern of which of the devices of the system is receiving/providing messages from/to the connecting device.

In accordance with an embodiment, a method includes: controlling, by a controller, a first device for packet timing, including assigning a first packet start time to the first device based on the first clock; and controlling, by the controller, a second device for packet timing, including assigning a second packet start time to the second device, where the second packet start time is based on the first clock and is offset in time from the first packet start time.

In accordance with an embodiment, a system includes: a controller; and a plurality of wireless devices configured to communicate with the controller, where the plurality of wireless devices includes a first wireless device and a second wireless device; where the first wireless device is configured to: transmit a first message using a first resolvable private address (RPA) that is different from a second RPA associated with the second wireless device, where the first RPA and the second RPA are resolvable to a single identity address; and where the controller is configured to: configure first parameters for the first wireless device and second parameters for the second wireless device, including causing the first wireless device to transmit the first message having a timing, set to avoid collision with messages transmitted by the second wireless device.

In accordance with an embodiment, an electronic device includes: a transceiver; and a processor configured to: transmit, via the transceiver, a first message including a first address associated with the electronic device; receive, via the transceiver, a response addressed to a second address that is different from the first address; generate a quality measurement value associated with the response; and transmit the quality measurement value to a controller.

In accordance with an embodiment, a method includes: causing, by a controller, a first device to transmit a first message; receiving, by the controller and responsive to the first message, a connection request from a second device via a third device, where the first and third devices are associated with a same electronic system; and responsive to the connection request, establishing a connection between the electronic system and the second device.

In accordance with an embodiment, a method includes: causing, by a controller, a first device to transmit a first message; receiving, by the controller, a connection request responsive to the first message from a second device via a third device; and responsive to the connection request, causing transmission of a connection response to the second device via the third device.

In accordance with an embodiment, an electronic device includes: a transceiver; and a processor configured to: receive, via the transceiver, a connection request from a first wireless device addressed to a second wireless device that is different from the electronic device; and responsive to the connection request, transmit, via the transceiver, a connection response to the first wireless device.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is an illustration of an example system in which a controlling device coordinates timing of advertisements from a multitude of devices, according to some embodiments;

FIG. 2 is an illustration of example system for coordinating packet times of multiple devices, according to some embodiments;

FIG. 3 is an illustration of an example time domain operation, according to some embodiments;

FIGS. 4A and 4B is an illustration of example time domain operation, according to some embodiments;

FIG. 5 is an illustration of example method, according to some embodiments;

FIG. 6 is an illustration of an example method, according to some embodiments;

FIG. 7 illustrates an example method, according to some embodiments; and

FIG. 8 is an illustration of two example wireless communication devices, which may be configured for packet timing, such as in the systems of FIG. 1 and FIG. 2, according to various embodiments.

Corresponding numerals and symbols in different figures generally refer to corresponding parts unless otherwise indicated. The figures are drawn to clearly illustrate the relevant aspects of the preferred embodiments and are not necessarily drawn to scale.

### DETAILED DESCRIPTION

The present disclosure is described with reference to the attached figures. The figures are not drawn to scale, and they are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

The making and using of the embodiments disclosed are discussed in detail below. It should be appreciated, however, that the present disclosure provides many applicable inventive concepts that can be embodied in a wide variety of specific contexts. The specific embodiments discussed are merely illustrative of specific ways to make and use the disclosure, and do not limit the scope of the disclosure.

The description below illustrates various specific details to provide an in-depth understanding of several example embodiments according to the description. The embodiments may be obtained without one or more of the specific details, or with other methods, components, materials and the like. In other cases, known structures, materials or operations are not shown or described in detail so as not to obscure the different aspects of the embodiments. References to “an embodiment” in this description indicate that a particular configuration, structure or feature described in relation to the embodiment is included in at least one embodiment. Consequently, phrases such as “in one embodiment” that may appear at different points of the present description do not necessarily refer exactly to the same embodiment. Furthermore, specific formations, structures or features may be combined in any appropriate manner in one or more embodiments.

Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

Some example BLE use cases may include a user desiring to connect a first device to a second device in a crowded radio frequency (RF) environment. For instance, a user may have a smart phone running an application that is configured to establish a connection with a wireless device of the user's car. However, a parking lot may be a crowded RF environment (with wireless devices on multiple cars making wireless transmissions, e.g., resulting in collisions between advertisers). Further, the user's car may include multiple wireless devices, where some of those devices may be less adversely affected by conditions of the RF environment than are other ones of the devices. Should the user's device attempt to connect to a device that is quite adversely affected by the conditions of the RF environment, that may cause the connection not to occur, resulting in delay and dissatisfaction for the user.

Embodiments of the present disclosure are described in specific contexts, e.g., a packet timing control system and method for using in Bluetooth Low Energy (BLE) communications. Some embodiments may be used in other communication protocols, such as some proprietary or standard-based wireless protocols. Some embodiments may be used in wired communication protocols, such as power line communication (PLC) protocols, wired networking protocols, or other serial or parallel wired communication protocols.

In one example, a controlling device may communicate with a multitude of BLE advertising devices. The controlling device may coordinate the packet timing of the BLE advertising devices. For instance, the controlling device may provide a shared clock for the advertising devices and then may assign respective packet start times for the advertising devices so that the advertisements do not collide with each other.

Continuing with the example, a first one of the advertising devices may broadcast a first advertisement packet, and the packet coordination will have established a time domain gap between the ending time of the first advertising packet and a beginning time of a second advertising packet from a second advertising device. During that time domain gap, a scanning device (e.g., a connecting device) may receive and decode the first advertising packet and in response transmit a connection indication addressed to the first advertising device. Each one of the advertising devices, including the first advertising device, may then receive the connection indication, analyze the quality of the signal of the connection indication, and transmit a result of the analysis to the controlling device.

The controlling device may receive the signal analysis from each of the advertising devices, compare the signal analysis to determine a satisfactory one of the advertising devices (e.g., the advertising device with a better quality metric among the advertising devices), and assign that satisfactory one of the advertising devices to connect with the connecting device. The satisfactory one of the advertising devices may be selected based upon the signal analysis received from the multitude of advertising devices, and the satisfactory one may be the same as the first advertising device or may be one of the other advertising devices. Some implementations may achieve a desirable result of reducing an amount of time experienced by the connecting device to establish a connection, which may further lead to increased user satisfaction.

Although this disclosure describes the networking environment in the context of a BLE network, other networks may implement the techniques of this disclosure. For example, the techniques of this disclosure can be implemented in a Wi-Fi network, a non-BLE Bluetooth network, a Zigbee network, a Thread network, a cellular network, a network having a combination of multiple protocols, etc.

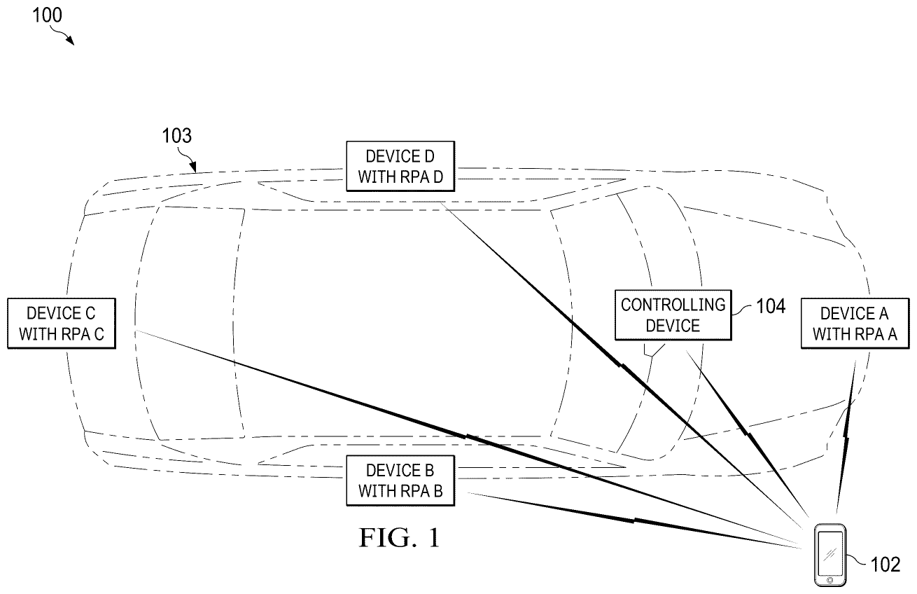

FIG. 1 is an illustration of an example system 100 in which a controlling device 104 coordinates timing of advertisements from a multitude of devices A-D, according to some embodiments. BLE technology uses advertisement packets in order for BLE advertisers to share information with BLE scanners and also to form connections with BLE initiators. Although FIG. 1 is shown in the context of an automotive system, the techniques of this disclosure may be implemented in other networking environments, including non-automotive vehicle networks, building networks, industrial networks, medical networks, data center/colocation facility networks, and so on.

This disclosure uses the following terminology: advertisers and initiators. Advertisers (e.g., vehicle nodes, interconnected nodes) may include BLE devices that send advertising packets, such as packets having ADV_IND or EXT_ADV_IND protocol data units (PDUs). A connecting device may also be referred to as an initiator (e.g. scanning device), which may include a BLE device that scans for advertisers and sends packets having CONNECT_IND or CONNECT_REQ PDUs to establish a connection with an advertiser.

For BLE advertisers and/or BLE initiators to remain private, BLE standard-based privacy methodology may be used. As an example, an Identity Resolving Key (IRK) is distributed and saved during the BLE Pairing process. A Resolvable Private Address (RPA) may be periodically generated by advertising, where the RPA includes hash (IRK, rand), e.g., the hash of the IRK and a random number. The BLE connecting devices that perform a pairing process, may resolve (e.g., perform the reverse hash) the RPA using the IRK and identify each other. The pairing process may also include the BLE advertisers and the BLE initiators storing one or more encryption keys to facilitate encrypted communications.

The vehicle nodes (interconnected BLE advertisers) may remain “Private,” e.g., to prevent tracking by foreign devices. The BLE advertised Bluetooth Address (e.g., a device identity address) may be shared across the nodes in the vehicle and may be set to the same address by the nodes themselves or by another entity. The BLE nodes in the vehicle may share the IRK across some or all of the BLE nodes in the vehicle. The BLE advertisers may generate a unique RPA to be resolved to the same logical address by an initiator.

In the present example, smart phone 102 acts as an initiator, Devices A-D are advertising devices (although some embodiments may include more than 4 advertising devices or less than 4 advertising devices), and vehicle 103 includes controlling device 104. In one example, controlling device 104 may be included in an electronic control unit (ECU) of vehicle 103, though the scope of implementations may include the controlling device 104 adapted to be located anywhere in vehicle 103. Further in this example, controlling device 104 may be communicatively coupled to the devices A-D by a wired or wireless technology. For example, controlling device 104 may be communicatively coupled with devices A-D by a wired bus, such as a controller area network (CAN) bus, a wireless technology such as BLE, or other appropriate technology.

Although FIG. 1 shows element 102 as a smartphone, it is understood that, in some embodiments, other devices may be used instead of a smartphone, such as a key fob, a smartphone or other device including a key fob, a smartwatch or other wearable, a tablet, and the like.

Further in this example, each of the devices A-D includes a same identity address, and each of the RPA addresses are different. Example system 100 implements a Synchronized Advertising Train (SAT) with passive scanning. The coordination of multiple advertising devices (e.g., devices A-D) described herein may include the transmission of the ADV_IND PDUs that may be issued by any one of the advertising devices. The packets having the ADV_IND PDUs are synchronized in time by a shared clock, which may be maintained by the controlling device 104.

A connecting device (e.g., smart phone 102) may send a single CONNECT_IND or REQ PDU to the advertising devices. Each of the advertising devices may listen to the CONNECT_IND or REQ PDU, which increases the probability of catching the signal, even if there is interference. Each of the advertising devices may then measure quality metric data of the signal each advertising device respectively receives and send the results of such measurement and/or associated analysis to the controlling device 104. The controlling device 104 may then determine which one of the advertising devices has a best, or at least acceptable, signal from the connecting device. The controlling device 104 may then assign a given one of the Devices A-D having a highest-quality signal to handle the connection (even if such device is not the device of Devices A-D that originated the advertisement packet that prompted the connection request).

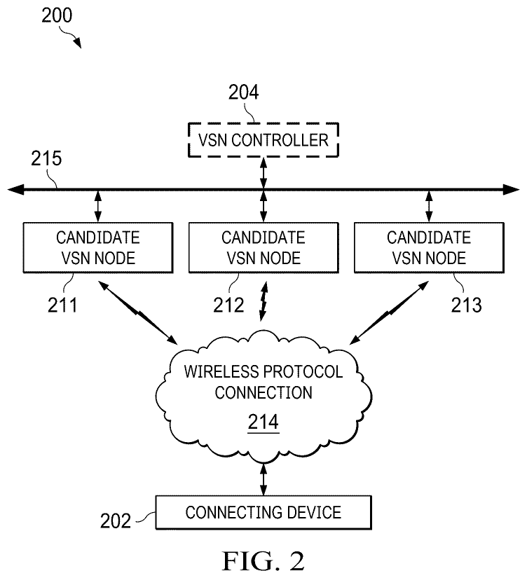

FIG. 2 is an illustration of example system 200, for coordinating packet times of multiple devices, according to some embodiments. FIG. 2 illustrates how the principles of system 100 of FIG. 1 may be applied generally to various network protocols and devices, such as may be associated with a Wi-Fi network, a non-BLE Bluetooth network, a Zigbee network, a Thread network, a cellular network, a network having a combination of multiple protocols, or the like.

System 200 illustrates a virtual synchronized network (VSN), which implements a synchronized advertising train (SAT). Each of the candidate VSN nodes 211-212 may be in communication with VSN controller 204 by communication protocol 215. As noted above, the communication protocol 215 may be, e.g., a standard or proprietary wired communication protocol such as CAN bus, or the like, or a standard or proprietary wireless communication protocol such as BLE, or the like.

VSN controller 204 may communicate with the candidate VSN nodes 211-213 via communication protocol 215 to establish a shared clock, set advertising intervals, set respective advertising start times, receive signal analysis from the candidate VSN nodes 211-213, and assign at least one of the candidate VSN nodes 211-213 to establish a connection 214 with connecting device 202.

The connecting device 202 may receive an advertisement packet from one of the candidate VSN nodes 211, respond to that advertising packet with a connection indication packet, and then establish wireless protocol connection 214 with at least one of the candidate VSN nodes 211-213 as selected by the VSN controller 204.

VSN controller 204 may be implemented with a generic or custom processor or controller, e.g., coupled to a memory and configured to store instructions in such memory. For example, in some embodiments, VSN controller 204 may include any appropriate processing circuit and may store computer executable code, which when executed by a processing circuit of VSN controller 204, may cause the processing circuit to perform actions associated with controlling device 104 of FIG. 1 and FIGS. 6 and 7. In some embodiments, VSN controller 204 includes a state machine. In some embodiments, VSN controller 204 is implemented with a field programmable gate array (FPGA). Other implementations are also possible.

Each of the candidate VSN nodes 211-213 may also include a respective processing circuit (e.g., generic or custom processor or controller, e.g., coupled to a memory and configured to store instructions in such memory) and may store computer executable code, which when executed by a processing circuit may cause the processing circuit to perform actions associated with Devices A-D of FIG. 1 and FIGS. 5 and 8. Although only three VSN nodes 211-213 are illustrated, the scope of implementations may be scaled to include any appropriate number of VSN nodes (e.g., such as 2, 3, 5, 6, 10, or more).

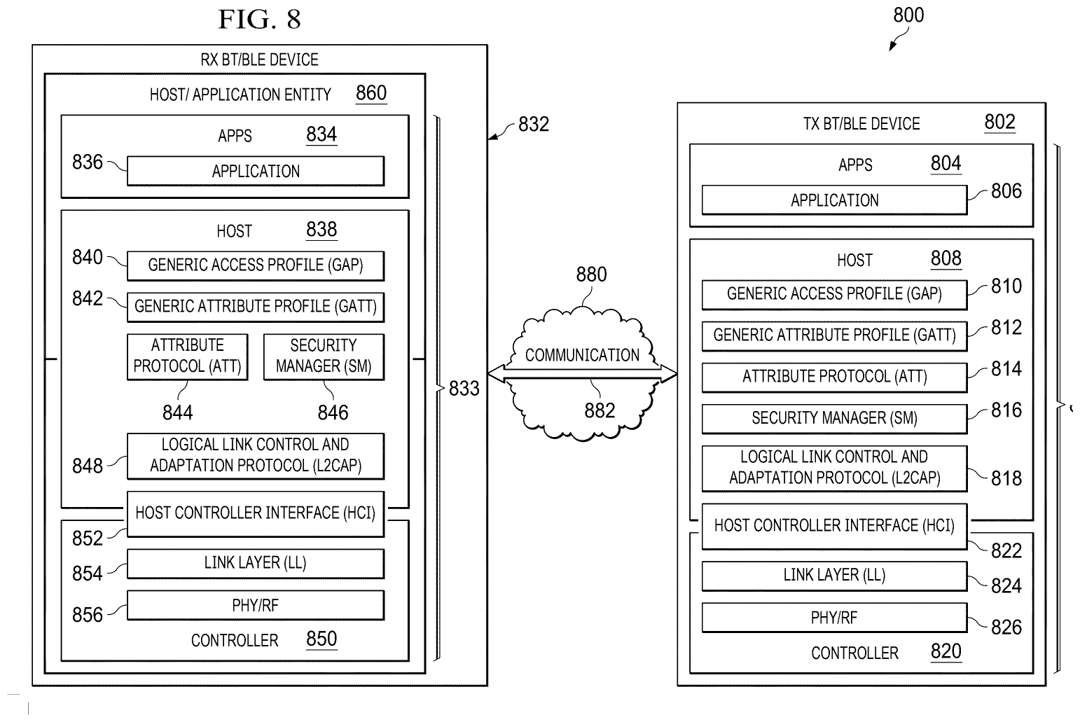

Connecting device 202 may also include any appropriate processing circuit, and in some embodiments may be implemented as a portable wireless device, such as a smart phone or tablet computer. Additional examples include any Internet of Things (IoT) device, a smart watch or other wearable, and the like. Connecting device 202 may include a processing circuit (e.g., generic or custom processor or controller, e.g., coupled to a memory and configured to store instructions in such memory) and may store computer executable code, which when executed by the processing circuit may cause the processing circuit to perform actions associated with smart phone 102 of FIG. 1 and FIG. 8. The processing circuit of connecting device 202 may include or be implemented with an FPGA. Other implementations are also possible.

Although VSN controller 204 is shown as being physically separate from each of the candidate VSN nodes 211-213, the scope of implementations is not so limited. Rather, functionality of VSN controller 204 may be implemented in a candidate VSN node. For instance, candidate VSN node 211 may perform the functionality of an advertising device and may also perform the coordinating functions of VSN controller 204.

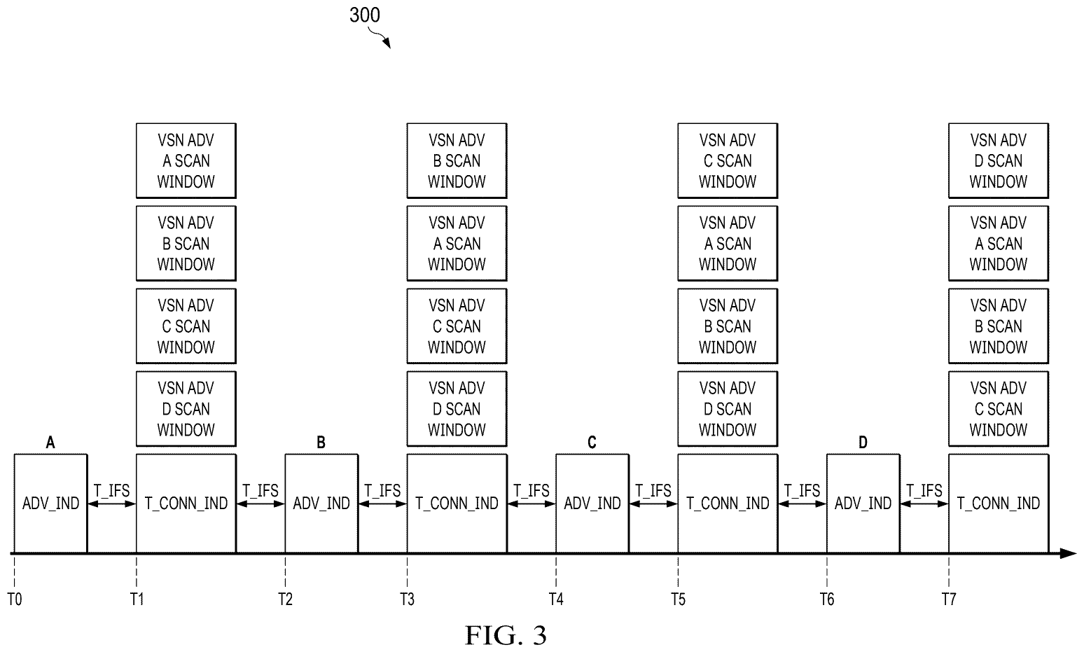

FIG. 3 is an illustration of an example time domain operation 300, according to some embodiments. The time domain operation 300 includes actions from four different advertising devices A-D as well as action from a connecting device (e.g., smart phone 102 or connecting device 202) and a controlling device (e.g., controlling device 104 or VSN controller 204).

At some time before T0, the controlling device may use control signaling to coordinate advertising packet timing of the devices A-D. For instance, the controlling device may assign an advertising interval and a respective packet start time to each of the devices A-D, where the interval and start times are selected to evenly space the advertising packets, such as illustrated in FIG. 3, e.g., such that the advertising packets of devices A-D do not collide with one another. In fact, in some embodiments, the spacings defined by the intervals and start times may not be even. If all nodes are aware of the SAT, then the nodes may show up to advertise and scan at the desired timing, where the timing may be random. Of course, it may be more efficient to pack the advertising as close as possible so that the SAT is as short as possible for fast response time. However any appropriate timing may be used.

In the present example, the advertising interval is equal to the time elapsed from time T0 through time T7 plus a time for a packet having a connection indication (T_CONNECT_IND) and an interframe spacing (T_IFS). Viewed another way, the time domain operation repeats as many times as is appropriate after time T7, so that after time T7, device A broadcasts an advertisement packet again. The starting time may be viewed as an offset from time T0, such that a starting time for device A has an offset of zero, whereas the starting time for device B is equal to the elapsed time between times T0 and time T2, the starting time for device C is equal to the elapsed time between times T0 and time T4, and the starting time for device D is equal to the elapsed time between times T0 and time T6.

Further in this example, the interval and starting times are set so that a time domain spacing between the start time of one advertising packet and the start time of the next subsequent advertising packet includes an elapsed time equal to two interframe spacing (T_IFS) times and a connection indication (T_CONNECT_IND) packet. In one example, an interframe spacing is 150 μs, and a connection indication packet is 272 μs, so that the elapsed time between time T0 and time T2 is 572 μs. However, the scope of implementation is not limited to any particular elapsed time. The repeating and non-colliding pattern of advertising packets of the time domain operation 300 may be referred to as a synchronized advertising train (SAT).

At time T0, device A begins broadcasting an advertising packet having a PDU of type ADV_IND. Similarly, at time T2, device B begins broadcasting an advertising packet having an ADV_IND PDU, at time T4, device C begins broadcasting an advertising packet having an ADV_IND PDU, and at time T6, device D begins broadcasting an advertising packet having an ADV_IND PDU. A connecting device may transmit a connection indication packet having a T_CONNECT_IND PDU in response to receiving an advertising packet. For instance, a connecting device may receive the advertising packet from device A and begin transmitting a connection indication packet at time T1. As illustrated, the connecting device may receive an advertising packet from any one of the devices A-D and in response transmit a connection indication packet beginning after an interframe spacing.

While FIG. 3 shows a connection indication packet after each one of the advertising packets, the connection indication packets are illustrated to describe the elapsed time between each advertising packet. In a use case, such as the automotive use case of FIG. 1, it would not be expected that a connection indication packet would follow each advertising packet.

It is generally expected that a connecting device may transmit a connection indication packet in response to a first device which it encounters. In the example of FIG. 1, a user having smart phone 102 may approach vehicle 103, such as by walking through a parking lot. The devices A-D of FIG. 1 may perform a time domain operation, such as time domain operation 300 to provide a SAT. The radio frequency (RF) signals of the devices A-D may be attenuated over a distance, though the smart phone 102 may arrive within a range at which one or more signals may be received and decoded. The smart phone 102 (the connecting device) may then send a connection indication packet addressed to a first device from which it was able to receive and decode the advertising packet. For instance, if the smart phone 102 receives and decodes the advertising packet from device B, then the smart phone 102 may transmit the connection indication packet at time T3 (e.g., and addressed to device B).

Continuing with the example, a connecting device may transmit a connection indication packet in response to receiving and decoding an advertising packet. Should the connecting device transmit the connection indication packet at time T3, the connecting device transmits the connection indication packet addressed to the RPA of device B. FIG. 3 illustrates listening windows (also referred to as scan windows) coinciding with the connection indication packets. For instance, the connection indication packet at time T3 overlaps in time with a listening window by all four of the devices A-D. In this example, even though the connection indication packet is addressed to the RPA of device B, each of the devices A-D may listen for and receive the connection indication packet from the connecting device and measures signal quality metric data associated with the connection indication packet. The listening windows may be implemented by, e.g., configuring each of the devices A-D to avoid entering a sleep mode during the times designated as the listening windows.

The time domain operation 300 includes listening windows for all four of the devices A-D corresponding to times T1, T3, T5, and T7. Furthermore, while none of the devices A-D are prohibited from listening during each listening window, it may happen in some instances that a device may not receive the connection indication packet. In such a case, the other ones of the devices A-D may receive the connection indication packet and measure signal quality metric data. In some embodiments, each of the devices A-D may be configured to receive, decode, and measure characteristics associated with connection indication packets, even when those connection indication packets may be addressed to a different device.

The signal quality metric data may include any appropriate signal quality measurement, such as a received signal strength indicator (RSSI), a link quality indicator (LQI), a distance measurement (e.g., time of flight and/or phase measurement), and the like. Each of the devices, having measured signal quality metric data during the listening window, then transmits its respective signal quality metric data to the VSN controller (e.g., VSN controller 204 or controlling device 104), e.g., during the same listening window (e.g., or after the listening window, such as during the subsequent T_IFS period or after). The devices may transmit the respective signal quality metric data to the VSN controller by any appropriate technique, such as over a wired connection, over a wireless connection, via a proxy device, or the like.

The VSN controller may then analyze the different respective signal quality metric data to determine an appropriate one of the devices A-D to assign as the device to connect to the connecting device. For instance, the VSN controller may rank RSSI measurements to determine one of the devices A-D having a highest signal strength. In another example, the VSN controller may rank LQI measurements to determine one of the devices having a highest link quality. In yet another example, the VSN controller may rank distance measurements to determine a device having a lowest phase difference.

Looking at the listening window corresponding to the connection indication packet of time T3, the VSN controller may then use appropriate control signaling to instruct one of the devices A-D to begin connecting to the connecting device, and the VSN controller may transmit the appropriate control signaling before time T4. In one example, the VSN controller may instruct device B to begin connecting to the connecting device. In such a scenario, the connection would then be established by the same device that transmitted the advertising packet that triggered the connecting device to transmit the connection indication packet. In another example, the VSN controller may instruct device C to begin connecting to the connecting device. In that scenario, the connection would then be established by a different device than the one that transmitted the advertising packet that triggered the connecting device to transmit the connection indication packet. In other words, the VSN controller may select a given one of the devices A-D based on the signal quality metric data, and the selected device may be different than the device associated with the immediately prior advertising packet.

In some embodiments, once a connection is established, the advertising device becomes a peripheral device, and the connecting device becomes a central device. The peripheral device may respond to the VSN controller that a connection has been established, and the VSN controller may instruct the other unconnected devices to cease advertising. On the other hand, should no connection be established, the time domain operation 300 may be repeated.

In some embodiments, once the connection between the connecting device and the VSN controller is established, the VSN controller may take an action in response to the connection being established, such as unlocking vehicle 103. For example, in some embodiments, the connecting device may transmit a request for an action to the VSN controller via the selected device (e.g., from devices A-D), such as locking/unlocking vehicle 103, start vehicle 103, or other actions.

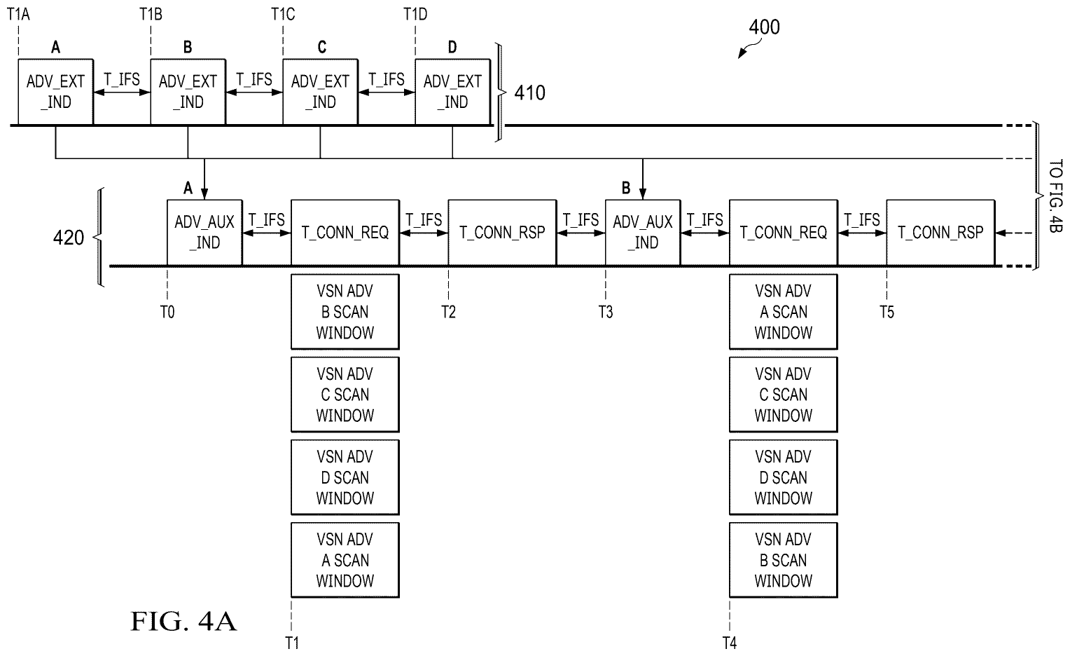

FIGS. 4A and 4B are an illustration of example time domain operation 400, according to some embodiments. While the example of FIG. 3 is directed toward the BLE legacy advertising (e.g., where all the communication occurs in a primary advertising channel), FIGS. 4A and 4B illustrate how the principles described herein may be applied to BLE extended advertising.

The example of FIGS. 4A and 4B includes the same four advertising devices A-D, which are in communication with a VSN controller (not shown) and with a connecting device that is configured to transmit packets having connection request (T_CONNECT_REQ) PDUs.

At time T1A, device A begins transmitting a packet having an extended advertising (ADV_EXT_IND) PDU. The same is true for device B (time T1B), device C (time T1C), and device D (time T1D). In this example, before time T1A, the VSN controller had assigned an extended advertising interval and respective start times to devices A-D to cause devices A-D to broadcast the extended advertising packets of SAT 410. Each of the extended advertising packets of SAT 410 is separated from its immediately subsequent neighbor by an interframe spacing.

In the present example, the SAT 410 is transmitted in a primary advertising channel (e.g., one of BLE channels 37, 38, 39). Each one of the advertising packets in SAT 410 points to a data channel and a time of a corresponding auxiliary packet (a packet having an ADV_AUX_IND PDU). For instance, the packet beginning at time T1A may point to a data channel and a timing of the auxiliary packet beginning at time T0. Although FIGS. 4A and 4B show only one SAT 410, other embodiments may include an SAT similar to 410 on additional primary advertising channels, where each of those SATs are offset from each other in time. Furthermore, it is understood that the SAT 410 may repeat according to the advertising interval set by the VSN controller.

Time domain operation 400 further includes SAT 420. SAT 420 is a synchronized train of auxiliary packets in a data channel (e.g., BLE channel 0). Device A transmits an auxiliary packet beginning at time T0; device B transmits an auxiliary packet beginning at time T3; device C transmits an auxiliary packet beginning at time T6, and device D transmits an auxiliary packet beginning at time T9. Each of the auxiliary packets is separated from its immediately subsequent neighbor by an elapsed time equal to three interframe spacings, a connection request packet, and a connection response packet (having a T_CONNECT_RSP PDU). In this example, a connection request packet spans 272 μs, as does a connection response packet, so that an elapsed time between time T0 and time T3 is 994 μs. Of course, the scope of implementations may be adapted for any given protocol and may include other appropriate elapsed times. In an example in which no connection request packet is transmitted in response to a particular auxiliary packet, no connection response packet would be transmitted either.

In the time domain operation 400, the scan windows are set to overlap with times for connection request packets. The scan windows in this example do not exclude any one of the devices A-D, just as in the example of FIG. 3. For instance, the scan window corresponding with the connection request packet at time Tl includes all four of the devices A-D listening, even though any connection request packet would be addressed to device a.

In one example, a connecting device (e.g., smart phone 102 or connecting device 202) may approach the devices A-D and receive and decode one of the extended advertising packets. For instance, the connecting device may receive and decode the extended advertising packet transmitted at time T1C from device C. The extended advertising packet may then point to a data channel and a timing offset corresponding to time T6. In response, the connecting device may then transmit a connection request packet at time T7, where that connection request packet is addressed to the RPA used by device C. There is a scan window overlapping in time with the connection request packet of time T7, and all of the devices A-D may receive the connection request packet, measure signal quality metric data associated with the connection request packet, and transmit that signal quality metric data (e.g., RSSI, LQI, distance measurement) to the VSN controller. Once again, the VSN controller may determine a best match based on the signal quality measurements from each of the devices A-D by ranking the signal quality metric data. The VSN controller may then instruct one of the devices A-D to transmit a connection response packet at time T8.

In one example, the VSN controller may determine that device C is a best match and may instruct device C to transmit the connection response packet for time T8. In that scenario, the same device that transmitted the extended advertising packet at time T1C and the auxiliary packet at time T6 is assigned to transmit the connection response packet.

In another example, the VSN controller may determine that one of the other devices different from device C (e.g., device D) is a best match and may instruct that device to transmit the connection response packet for time T8. In that scenario, the device that transmits the connection response packet is different from the device that transmitted the extended advertising packet and auxiliary packet that triggered the connection request at time T7.

The examples described herein may advantageously allow for selection of the best BLE advertiser to serve a specific BLE connecting device. There are multiple advantages to this approach, e.g., in the automotive access use case of FIG. 1. For example, selecting the best BLE advertiser may advantageously increase the probability of a connection being formed. Connection indication packets (and connection request packets) may be lost due to interference, timing etc.; however, this packet loss may be advantageously solved by the redundancy offered in the examples herein because more than one device is listening for the connection indication (or connection request) packet. Even if one device misses the connection indication or connection request, other devices may pick up the connection indication or request, and a connection may be established. Thus, a potential advantage may include reduced connection time and increased user satisfaction.

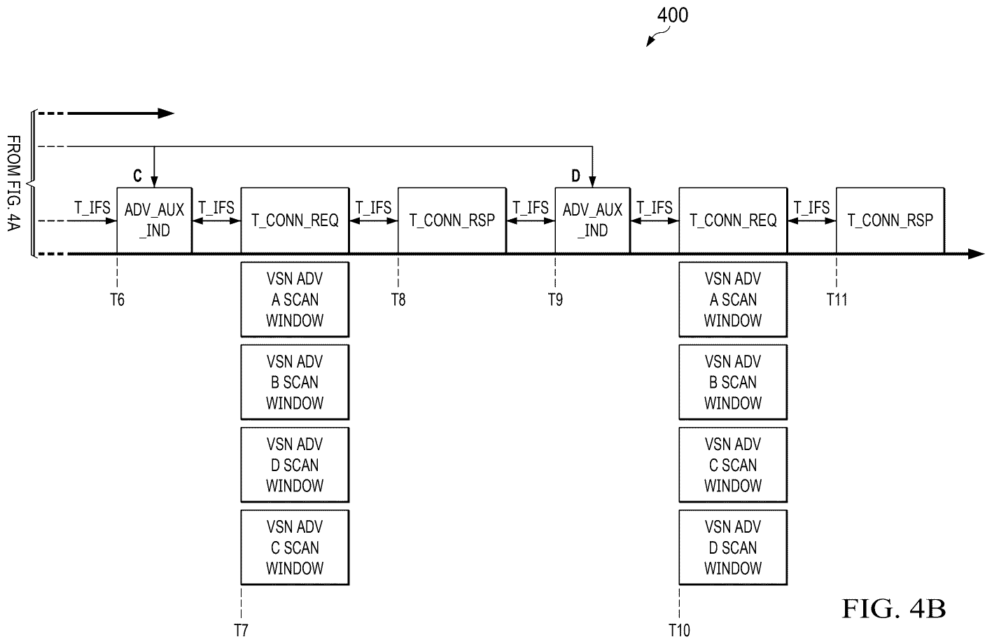

FIG. 5 is an illustration of example method 500, according to some embodiments. Example method 500 may be performed by an electronic device, such as any of the devices A-D of FIG. 1 or any of the candidate VSN nodes 211-213 of FIG. 3. For instance, the electronic device may execute computer-readable code to provide the functionality of method 500. In another example, the functionality of method 500 may be implemented in hardware logic.

At action 502, the electronic device includes a transceiver, and the device transmits, via the transceiver, a first message including a first address associated with the electronic device. In one example, the device may transmit an advertising packet, such as device A transmitting an advertising packet at time T0 in FIG. 3. In another example, a device may transmit an auxiliary packet, such as device A transmitting an auxiliary packet at time T0 of FIGS. 4A and 4B.

Continuing with action 502, the packet includes an address. In one example, the address may include an RPA, such as may be used for privacy operations in BLE. As noted above, in some examples, each of the different devices may have a same underlying identity address but use respective RPAs for advertising and for communicating with connecting devices. In such scenarios, the devices using different RPAs may still be seen as a single logical entity by a connecting device that resolves the different RPAs to the same identity address. The connecting device, when responding to a particular device, may then use that device's RPA rather than its underlying identity address. Of course, the scope of implementations may include any addressing scheme.

At action 504, the electronic device receives, via the transducer, a response addressed to a second address that is different from the first address. For instance, some time might have elapsed since device A transmitted an advertising packet or auxiliary packet. In such case, another device (e.g., device B) participating in the SAT may have transmitted a subsequent advertising packet or auxiliary packet. A connecting device may have received that subsequent advertising packet or auxiliary packet and may have responded with a connection indication or connection request addressed to device B. Nevertheless, in method 500, the first device (e.g., device A) receives and perhaps decodes the response.

At action 506, the device (e.g., device A) generates signal quality metric data associated with the response. Examples of signal quality metric data are given above, including RSSI, LQI, and distance measurement. The device may then transmit the signal quality metric data over a communication technology (e.g., communication protocol 215) to a controller at action 508. Examples of controllers include the controlling device 104 of FIG. 1 and the VSN controller of FIG. 2.

The scope of implementations may include other actions in method 500. For instance, the device may receive an instruction from the controller to establish a connection with the connecting device. On the other hand, the device may receive no instruction from the controller, as the controller may instruct another device to establish a connection with the connecting device.

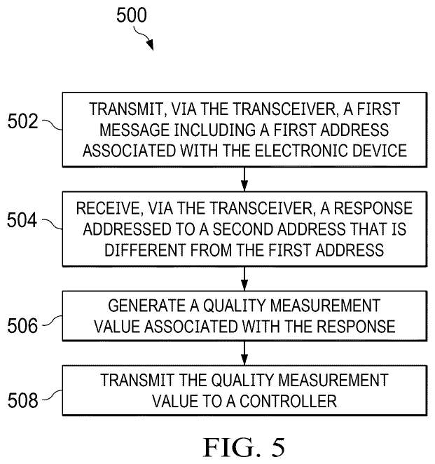

FIG. 6 illustrates an example method 600, according to some embodiments. Example method 600 may be performed by an electronic device implemented as a controller, such as controlling device 104 of FIG. 1 or VSN controller 204 of FIG. 2. For instance, the electronic device may execute computer-readable code to provide the functionality of method 600. In another example, the functionality of method 600 may be implemented in hardware logic.

Further in this example, the controller also provides functionality of an advertising device. For instance, as noted above, any of the devices A-D of FIG. 1 and any of the candidate VSN nodes 211-213 of FIG. 2 may implement controller functionality.

At action 602, the controller may cause a first device to transmit a first message. In one example, the controller may assign an advertising interval and respective start times to a multitude of advertising devices. An example is shown in FIG. 3, where a controller has assigned devices A-D to operate according to an advertising interval and respective start times to result in a SAT. In such an example, the first message may be an advertising packet. Another example is shown in FIGS. 4A and 4B, where a controller has assigned devices A-D to operate according to an advertising interval and respective start times to result in SAT 420. In such example, the first message may be an auxiliary packet.

At action 604, the controller receives, responsive to the first message, a connection request from a second device. For instance the connection request may include a connection indication packet, a connection request packet, or other packet. The first message triggers a connecting device (the second device) to transmit the connection request addressed to the first device. Further in this example, the controller receives the connection request via a third device. For instance, the third device may have received the connection request packet, addressed to the first device, through passive listening.

Action 604 may also include the controller receiving signal quality metric data from the various devices, including the first device and the third device. The signal quality metric data may include, e.g., RSSI data, LQI data, distance measurement data, or the like. The signal quality metric data may indicate a quality of a signal received by a respective one of the first device or the third device.

Also, the first device and the third device may be associated with a same electronic system. For instance, the electronic system may be an automobile, an industrial sensor system, or the like, where the first device and the third device have a same underlying identity address. In other words, the first device and the third device (and any other associated devices) may form a single logical peripheral device, though they may use different RPAs. Thus, the connection request may be addressed to an RPA associated with the first device.

At action 606, the controller, responsive to the connection request, establishes a connection between the electronic system (e.g., a logical peripheral device) and the second device. For instance, the controller may receive signal quality metric data from the various devices, may rank that signal quality metric data, and may select a best one of either the first device or the second device (or any other devices) to establish a connection with the second device. For instance, the controller may select the first device based on the signal quality metric data, may select the third device based on the signal quality metric data, or if the electronic system includes other devices may select a fourth device.

The controller may be incorporated in one of the devices, such as the first device or the third device. In other words, the controller may be incorporated in the device selected to establish the connection or may be incorporated in a device not selected to establish the connection.

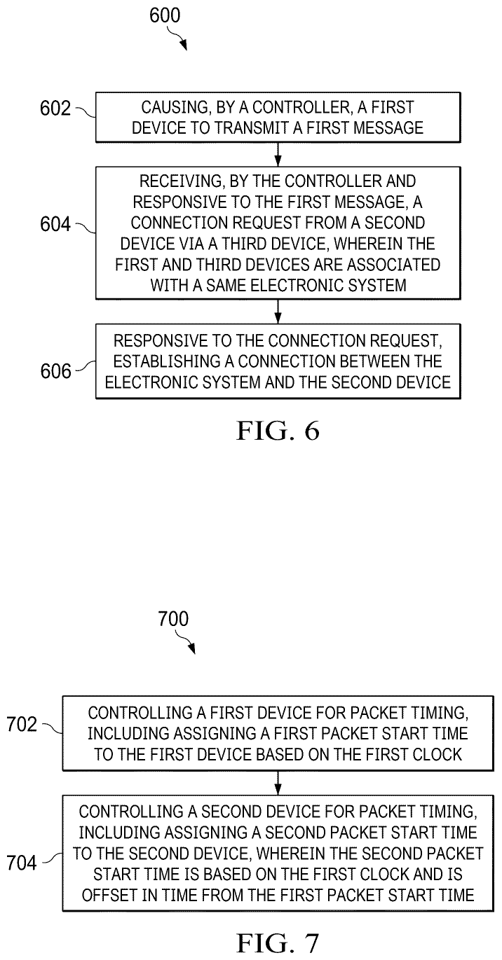

FIG. 7 illustrates an example method 700, according to some embodiments. Example method 700 may be performed by an electronic device implemented as a controller, such as controlling device 104 of FIG. 1 or VSN controller 204 of FIG. 2. For instance, the electronic device may execute computer-readable code to provide the functionality of method 700. In another example, the functionality of method 700 may be implemented in hardware logic.

At action 702, the controller controls a first device for packet timing. Action 702 may include assigning a first packet start time to the first device based on a clock that is shared among the controller, the first device, and other devices. The first device and the other devices may be associated with a same peripheral and may share a common underlying identity address.

Action 702 may include assigning an advertising interval as well. For instance, in the SAT of FIG. 3, the advertising interval includes the time from time T0 to time T7 plus an interframe spacing plus a time domain length of a connection indication packet. In the example of FIGS. 4A and 4B, SAT 410 has an advertising interval equal to the elapsed time between time T1A to time T1D, plus a time for an extended packet and an interframe spacing. Similarly, the advertising interval of SAT 420 is equal to the elapsed time from time T0 through time T11, plus the time for a connection response and an interframe spacing.

At action 704, the controller controls a second device for packet timing. In this example, the second device may share the clock with the first device and possibly other devices and be associated with the same peripheral.

Action 704 may include the controller assigning the advertising interval from action 702 to the second device as well as assigning a second packet start time that is offset from the first packet start time. For instance, in the example of FIG. 3, the packet at time T0 may be associated with the first device, and the packet at time T2 may be associated with a second device. The start time of the packet at time T2 may be offset by a time domain length of an advertising packet, two interframe spacings, and a time domain length of a connection indication from time T0. As a result, the first device and the second device may both advertise over multiple cycles of an STA without colliding.

In the example of FIGS. 4A and 4B, the extended advertising packets of STA 410 and the auxiliary packets of STA 420 also have offset starting times and advertising intervals that prevent collision.

Although the example of FIG. 7 refers to a first device and a second device, method 700 may be adapted for additional devices. For instance, the first device, the second device and further devices may be associated with a same electronic system. Those further devices may also be assigned the advertising interval and respective start times by the controller so that all of the devices associated with the electronic system may advertise and avoid collision.

The controller may allow the first device and the second device (and any other devices) to advertise over multiple cycles of a time domain operation. In the example of FIG. 3, the time domain operation may include each of the devices A-D broadcasting advertisement packets according to their respective timings in the SAT for multiple repetitions of the time domain operation 300 until a connection is established. The same is true for the example of FIGS. 4A and 4B and its SATs 410 and 420.

FIG. 8 is an illustration of an example first Bluetooth (BT) or Bluetooth Low Energy (BLE) device 832 and a second BT/BLE device 802, according to various embodiments. In some embodiments, device 102 may be implemented as device 802 and each of devices A-D of FIG. 1 may be implemented as a device 832.

In some embodiments, example devices 832 and 802 may include functionality in their link layers 854, 824 to advertise in a SAT and to listen in a scan window for responses, where those responses may be directed to that particular device or another device.

In one example, device 802 may be physically implemented as circuits on a first semiconductor device, and device 832 may similarly be physically implemented as circuits on a second semiconductor device. Each of the devices 802, 832 may be included in separate semiconductor packages as appropriate.

In the present example, both devices 832 and 802 are capable of transmitting and receiving. The BT/BLE device 832 (e.g., a key fob, a wearable device, a smartphone, a sensor, an in-vehicle component, or other device with BT/BLE functionality) is in communication with the BT/BLE device 802 (e.g., another key fob, a wearable device, a smartphone, a sensor, an in-vehicle component, or other device with BT/BLE functionality) via wireless communication channels 880. Wireless communications 882 are received by the BT/BLE device 832 and transmitted from the BT/BLE device 802 (and vice versa) via the wireless communication channels 880.

The BLE standard defines a hierarchy of layers and components to be implemented by each electronic device to support low-power wireless communications. The bottom layer defined by the BLE standard is the BLE controller 820, 850, which includes the physical (PHY) layer and a radio frequency (RF) layer 826, 856. The RF layer may include a transducer, such as a transceiver, to send and receive RF signals under control of the controller 820, 850. Above the BLE controller is the BLE host 808, 838. Above the BLE host layer 808, 838 resides the application layer 804, 834 with applications 806, 836 configured to send or receive data via the BLE host layer and BLE controller layer. In BLE, communication channels include data channels and advertisement channels. In some embodiments, the devices 802, 832 communicate using data channels. In BLE, each data channel has a unique band between 2.4 GHz and 2.4835 GHz, and each of those channels has unique frequency-dependent characteristics.

In the example of FIG. 8, the BT/BLE device 802 includes a BT/BLE stack 803 with an application layer 804, a host layer 808, and a controller layer 820. The application layer 804 includes one or more applications 806 executed by the BT/BLE device 802. The host layer 808 includes a generic access profile (GAP) 810, a generic attribute profile (GATT) 812, an attribute protocol (ATT) 814, a security manager (SM) 816, and a logic link control and adaptation protocol (L2CAP) 818. The controller layer 820 includes a link layer (LL) 824 and PHY/RF layers 826. In some example embodiments, the BT/BLE device 802 uses dedicated signaling (e.g., API signaling) referred to as host controller interface (HCl) 822 to communicate between the host layer 808 and the controller layer 820.

The BT/BLE device 832 includes a BT/BLE stack 833 with an application layer 834, a host layer 838, and a controller layer 850. The application layer 834 includes one or more applications 836 executed by the RX BT/BLE device 830. The host layer 838 includes GAP 840, GATT 842, ATT 844, SM 846, and L2CAP 848. The controller layer 820 includes LL 854 and PHY/RF layers 856. In some example embodiments, the RX BT/BLE device 830 uses dedicated signaling (e.g., application programming interface signaling) referred to as HCl 852 to communicate between the host layer 838 and the controller layer 850. In some example embodiments, the application layer 834 and/or the host layer 838 are in communication with a host/application entity 860.

In some examples, controllers 850 and 820 may be responsible for BLE Privacy. For instance, the controllers 850 and 820 may have access to RPAs, may generate RPAs from hash (IRK, rand), may resolve RPAs, and the like.

Various implementations described herein may be symmetrical with respect to a peripheral device and a central device. For instance, in a BLE scenario, such as which is illustrated in FIG. 8, the central device and peripheral device may play distinct roles in facilitating efficient and low-power data exchange. For example, the central device typically assumes the role of overseeing and managing the communication process. In some examples, the central device initiates connections, controls data transmission intervals, and coordinates communication with one or more peripheral devices. In some examples, peripheral devices respond to the requests from the central device and transmit data as needed. Peripheral devices may be designed to be power-efficient, often operating in a sleep mode and waking up only when necessary to conserve energy. This central-peripheral relationship allows for a flexible and energy-efficient network configuration, making BLE technology appropriate for some applications such as wearable devices, smart sensors, and other Internet of Things (IoT) implementations where low power consumption is beneficial.

The advertiser and controller functionalities described herein may be performed by software, firmware, or hardware logic. For instance, in some example embodiments, the actions to assign advertising times, advertise it those times, listen for responses, provide signal quality metric data, and/or the like may be performed by a processing device (e.g., either of controllers 820, 850) executing computer-readable code.

In some embodiments, controller 820 may be implemented with a generic or custom processor or controller, e.g., capable of executing instructions stored in an associated memory. In some embodiments, controller 820 may be implemented in hardware using state machines. Other implementations are also possible.

In some embodiments, controller 850 may be implemented with a generic or custom processor or controller, e.g., capable of executing instructions stored in an associated memory. In some embodiments, controller 850 may be implemented in hardware using state machines. Other implementations are also possible.

In some embodiments, host 808 may be implemented with a generic or custom processor or controller, e.g., capable of executing instructions stored in an associated memory. In some embodiments, host 808 may be implemented in hardware using state machines. Other implementations are also possible.

In some embodiments, host 838 may be implemented with a generic or custom processor or controller, e.g., capable of executing instructions stored in an associated memory. In some embodiments, host 808 may be implemented in hardware using state machines. Other implementations are also possible.

In some embodiments, host 808 and 820 may be combined and may be implemented using, e.g., a single, e.g., generic or custom processor or controller, e.g., capable of executing instructions stored in an associated memory.

In some embodiments, host 838 and controller 850 may be combined and may be implemented using, e.g., a single, e.g., generic or custom processor or controller, e.g., capable of executing instructions stored in an associated memory.

Example embodiments of the present disclosure are summarized here. Other embodiments can also be understood from the entirety of the specification and the claims filed herein.

Example 1. A method including: controlling, by a controller, a first device for packet timing, including assigning a first packet start time to the first device based on the first clock; and controlling, by the controller, a second device for packet timing, including assigning a second packet start time to the second device, where the second packet start time is based on the first clock and is offset in time from the first packet start time.

Example 2. The method of example 1, where a first packet associated with the first packet start time, and a second packet associated with the second packet start time, each includes an advertising indication.

Example 3. The method of one of examples 1 or 2, further including receiving, by the controller and via the second device, a connection request responsive to the first or second packet from a third device via the first device.

Example 4. The method of one of examples 1 to 3, where the third device is a smartphone or a key fob.

Example 5. The method of one of examples 1 to 4, where the first device includes the controller.

Example 6. The method of one of examples 1 to 5, where the second device includes the controller.

Example 7. The method of one of examples 1 to 6, where a vehicle includes the first and second devices, and the controller.

Example 8. The method of one of examples 1 to 7, where the first device and the second device are configured to transmit outward from the vehicle.

Example 9. The method of one of examples 1 to 8, where the first packet includes a protocol data unit (PDU) according to a Bluetooth Low Energy (BLE) protocol.

Example 10. The method of one of examples 1 to 9, where the first packet start time is offset from the second packet start time by an elapsed time equal to a time domain length of an advertisement packet plus two time domain lengths of an inter frame space (TIFS) plus a time domain length of a connection indication packet.

Example 11. The method of one of examples 1 to 10, where a first packet associated with the first packet start time and a second packet associated with the second packet start time are part of a plurality of packets transmitted on a primary advertising channel.

Example 12. The method of one of examples 1 to 11, further including: controlling the first device for packet timing on one or more secondary advertising channels, including assigning a third packet start time to the first device and based on the first clock; and controlling the second device for packet timing on the one or more secondary advertising channels, including assigning a fourth packet start time to the second device and based on the first clock.

Example 13. The method of one of examples 1 to 12, where the third packet start time is offset from the fourth packet start time by an elapsed time equal to a time domain length of an auxiliary advertisement packet plus two time domain lengths of an inter frame space (TIFS) plus a time domain length of a connection request packet.

Example 14. The method of one of examples 1 to 13, where the first device is associated with a first resolvable private address (RPA), and where the second device is associated with a second RPA, where the first RPA and the second RPA are configured to resolve to a same device address.

Example 15. The method of one of examples 1 to 14, where controlling the first device and controlling the second device includes exchanging control signals between the controller and the first and second devices via a wired bus.

Example 16. The method of one of examples 1 to 15, where controlling the first device and controlling the second device includes exchanging control signals between the controller and the first and second devices via a wireless medium.

Example 17. The method of one of examples 1 to 16, further including: controlling the controller for advertisement packet timing, including assigning a fifth packet start time to the controller based on the first clock.

Example 18. The method of one of examples 1 to 17 further including: receiving, by the controller, first quality metric data from the first device, where the first quality metric data refers to signal quality of a first packet addressed to the second device and as received by the first device; and receiving second quality metric data from the second device, where the second quality metric data refers to signal quality of the first packet as received by the second device.

Example 19. The method of one of examples 1 to 18, further including: analyzing, by the controller, the first quality metric data and the second quality metric data; and instructing the first device to connect to a connecting device based at least in part on the analyzing.

Example 20. The method of one of examples 1 to 19, where the first quality metric data includes first received signal strength indicator (RSSI) data, and the second quality metric data includes second RSSI data, and where the method further includes: analyzing, by the controller, the first RSSI data in the second RSSI data, and instructing either the first device or the second device to connect to a connecting device based on which one of the first device or the second device has a highest RSSI.

Example 21. The method of one of examples 1 to 20, where the first quality metric data includes first link quality indicator (LQI) data, and the second quality metric data includes second LQI data, and where the method further includes: analyzing, by the controller, the first LQI data in the second LQI data, and instructing either the first device or the second device to connect to a connecting device based on which one of the first device or the second device has a highest LQI.

Example 22. The method of one of examples 1 to 21, where controlling the first device for packet timing and controlling the second device for packet timing includes assigning the first packet start time and the second packet start time to ensure advertisement packets of the first device avoid collision with advertisement packets of the second device.

Example 23. The method of one of examples 1 to 22, further including: synchronizing the first device and the second device with the controller according to a common timing of the first clock.

Example 24. A system including: a controller; and a plurality of wireless devices configured to communicate with the controller, where the plurality of wireless devices includes a first wireless device and a second wireless device; where the first wireless device is configured to: transmit a first message using a first resolvable private address (RPA) that is different from a second RPA associated with the second wireless device, where the first RPA and the second RPA are resolvable to a single identity address; and where the controller is configured to: configure first parameters for the first wireless device and second parameters for the second wireless device, including causing the first wireless device to transmit the first message having a timing, set to avoid collision with messages transmitted by the second wireless device.

Example 25. The system of example 24, where the controller is configured to communication with the plurality of wireless devices using a controller area network (CAN) protocol.

Example 26. The system of one of examples 24 or 25, further including a vehicle, where the controller, the first wireless device, and the second wireless device are included within the vehicle.

Example 27. The system of one of examples 24 to 26, further including an automobile electronic control unit (ECU), where the controller is implemented within the ECU.

Example 28. The system of one of examples 24 to 27, where the controller and the first wireless device are implemented as a same device.

Example 29. The system of one of examples 24 to 28, where the first wireless device is further configured to: receive a connection indication addressed to the second RPA; generate quality metric data associated with the connection indication; and transmit the quality metric data to the controlling device.

Example 30. The system of one of examples 24 to 29, where the first wireless device is configured to generate the quality metric data by generating received signal strength information (RSSI) data.

Example 31. The system of one of examples 24 to 30, where the first wireless device is configured to generate the quality metric data by generating link quality indicator (LQI) data.

Example 32. The system of one of examples 24 to 31, where the first wireless device is configured to generate the quality metric data by generating distance measurement data.

Example 33. The system of one of examples 24 to 32, where the controller is further configured to: receive the quality metric data from the first wireless device; receive further quality metric data, associated with the connection indication, from the second wireless device; and assign either the first wireless device or the second wireless device to connect to a connecting device, associated with the connection indication, based on analyzing the quality metric data and the further quality metric data.

Example 34. The system of one of examples 24 to 33, where the controller is further configured to: analyze the quality metric data and further quality metric data, associated with the connection indication, from the second wireless device; and assign the first wireless device to connect to a connecting device, associated with the connection indication, based on analyzing the quality metric data and the further quality metric data.

Example 35. The system of one of examples 24 to 34, where the controller is further configured to: analyze the quality metric data and further quality metric data, associated with the connection indication, from the second wireless device; and assign the first wireless device to connect to a key fob, associated with the connection indication, based on analyzing the quality metric data and the further quality metric data.

Example 36. The system of one of examples 24 to 35, where the first wireless device is configured to be paired with a smart phone, including being programmed to store an encryption key shared with the smart phone, and where the first wireless device is configured to share an identity resolving key, associated with the first RPA, with the smart phone.

Example 37. The system of one of examples 24 to 36, where the first wireless device and the second wireless device are configured as Bluetooth Low Energy (BLE) devices.

Example 38. The system of one of examples 24 to 37, where the timing is a common timing according to the first clock.

Example 39. An electronic device including: a transceiver; and a processor configured to: transmit, via the transceiver, a first message including a first address associated with the electronic device; receive, via the transceiver, a response addressed to a second address that is different from the first address; generate a quality measurement value associated with the response; and transmit the quality measurement value to a controller.

Example 40. The electronic device of example 39, where the quality measurement data includes an RSSI value associated with the response.

Example 41. The electronic device of one of examples 39 or 40, where the quality measurement data includes an LQI value associated with the response.

Example 42. The electronic device of one of examples 39 to 41, where the processor is configured to transmit the first message as a first packet of a plurality of packets from a respective plurality of electronic devices in a synchronized advertising train, where the plurality of electronic devices includes the electronic device.

Example 43. The electronic device of one of examples 39 to 42, where the processor is configured to transmit the first message using a first resolvable private address (RPA) and to resolve a second RPA associated with the response.

Example 44. The electronic device of one of examples 39 to 43, where the processor is further configured to: implement a controller layer and a host layer, where the controller layer is configured to have access to the first RPA and the second RPA.

Example 45. The electronic device of one of examples 39 to 44, where the controller layer is configured to not report the first RPA or the second RPA to the host layer, and where the controller layer is configured to resolve the first RPA and the second RPA to a first identity address and to report the first identity address to the host layer.

Example 46. The electronic device of one of examples 39 to 45, where the processor is further configured to avoid entering a sleep mode.

Example 47. The electronic device of one of examples 39 to 46, where the first electronic device includes a Bluetooth Low Energy (BLE) peripheral device.

Example 48. The electronic device of one of examples 39 to 47, where the processor is further configured to: receive one or more control signals from the controller, the one or more control signals identifying a particular electronic device of a plurality of electronic devices to proceed with a connection to a connecting device associated with the response.

Example 49. The electronic device of one of examples 39 to 48, where the processor is further configured to: establish a connection with the connecting device in response to determining that the one or more control signals identify the electronic device.

Example 50. A method including: causing, by a controller, a first device to transmit a first message; receiving, by the controller and responsive to the first message, a connection request from a second device via a third device, where the first and third devices are associated with a same electronic system; and responsive to the connection request, establishing a connection between the electronic system and the second device.

Example 51. The method of example 50, where establishing the connection between the electronic system and the second device includes causing transmission of a connection response to the second device.

Example 52. The method of one of examples 50 or 51, where causing transmission of the connection response to the second device includes causing a fourth device to transmit the connection response to the second device, where the fourth device is associated with the same electronic system.

Example 53. The method of one of examples 50 to 52, where the connection request includes a CONNECT_IND protocol data unit (PDU), and where the first message includes an ADV_IND PDU.

Example 54. The method of one of examples 50 to 53, where the connection request includes a CONNECT_REQ protocol data unit (PDU), and where the first message includes an ADV_AUX_IND PDU.

Example 55. The method of one of examples 50 to 54, further including: receiving, by the controller and responsive to the first message, first quality metric data from the first device and second quality metric data from the third device, where the first quality metric data and the second quality metric data are associated with the connection request.

Example 56. The method of one of examples 50 to 55, further including: selecting the first device for establishing the connection based on determining that the first quality metric data is greater than the second quality metric data.

Example 57. The method of one of examples 50 to 56, further including selecting the third device for establishing the connection based on determining that the second quality metric data is greater than the first quality metric data.

Example 58. The method of one of examples 50 to 57, where the first quality metric data and the second quality metric data include received signal strength indicator (RSSI) data.

Example 59. The method of one of examples 50 to 58, where the first quality metric data and the second quality metric data include link quality indicator (LQI) data.

Example 60. The method of one of examples 50 to 59, where the first quality metric data and the second quality metric data include distance measurement data.

Example 61. The method of one of examples 50 to 60, where the first device transmits the first message using a first resolvable private address (RPA), and where the third device transmits a second message using a second RPA, where the first RPA and the second RPA resolve to a same identity address.

Example 62. A method including: causing, by a controller, a first device to transmit a first message; receiving, by the controller, a connection request responsive to the first message from a second device via a third device; and responsive to the connection request, causing transmission of a connection response to the second device via the third device.

Example 63. The method of example 62, where the first device and second devices are associated with a same electronic system, the method further including, establishing a connection between the electronic system and the second device responsive to the connection response.

Example 64. The method of one of examples 62 or 63, where the connection request includes a CONNECT_IND protocol data unit (PDU), and where the first message includes an ADV_IND PDU.

Example 65. The method of one of examples 62 to 64, where the connection request includes a CONNECT_REQ protocol data unit (PDU), and where the first message includes an ADV_AUX_IND PDU.

Example 66. The method of one of examples 62 to 65, further including: receiving, by the controller and responsive to the first message, first quality metric data from the first device and second quality metric data from the third device, where the first quality metric data and the second quality metric data are associated with the connection request.

Example 67. The method of one of examples 62 to 66, further including: selecting the third device for transmitting the connection response based on determining that the second quality metric data is greater than the first quality metric data.

Example 68. The method of one of examples 62 to 67, where the first quality metric data and the second quality metric data include received signal strength indicator (RSSI) data.

Example 69. The method of one of examples 62 to 68, where the first quality metric data and the second quality metric data include link quality indicator (LQI) data.

Example 70. The method of one of examples 62 to 69, where the first quality metric data and the second quality metric data include distance measurement data.

Example 71. The method of one of examples 62 to 70, where the first device transmits the first message using a first resolvable private address (RPA), and where the third device transmits the connection response using a second RPA, where the first RPA and the second RPA resolve to a same identity address.

Example 72. An electronic device including: a transceiver; and a processor configured to: receive, via the transceiver, a connection request from a first wireless device addressed to a second wireless device that is different from the electronic device; and responsive to the connection request, transmit, via the transceiver, a connection response to the first wireless device.

Example 73. The electronic device of example 72, where the processor is configured to cause the electronic device to transmit the connection response using a first resolvable private address (RPA), further where the processor is configured to cause the electronic device to receive the connection request having a second RPA, where the first RPA and the second RPA are different.

Example 74. The electronic device of one of examples 72 or 73, where the processor is configured to resolve the second RPA to an identity address, where the processor is configured to generate the first RPA using the identity address.

Example 75. The electronic device of one of examples 72 to 74, where the processor is further configured to generate quality metric data from the connection request.

Example 76. The electronic device of one of examples 72 to 75, where the quality metric includes received signal strength indicator (RSSI) data.

Example 77. The electronic device of one of examples 72 to 76, where the quality metric data includes link quality indicator (LQI) data.

Example 78. The electronic device of one of examples 72 to 77, where the quality metric data includes distance measurement data.

Example 79. The electronic device of one of examples 72 to 78, where the processor is further configured to receive control signals, from a controller, where the control signals indicate to the electronic device to respond to the connection request.

Example 80. The electronic device of one of examples 72 to 79, where the transceiver is configured to receive the control signals from the controller via a wired bus.

Example 81. The electronic device of one of examples 72 to 80, where the transceiver is configured to receive the control signals from the controller via Bluetooth Low Energy (BLE) protocol.

Corresponding numerals and symbols in the different figures generally refer to corresponding parts, unless otherwise indicated. The figures are not necessarily drawn to scale. In the drawings, like reference numerals refer to like elements throughout, and the various features are not necessarily drawn to scale.

While various examples of the present disclosure have been described above, it should be understood that they have been presented by way of example only and not limitation. Numerous changes to the disclosed examples can be made in accordance with the disclosure herein without departing from the spirit or scope of the disclosure. Modifications are possible in the described embodiments, and other embodiments are possible, within the scope of the claims.

What is claimed is:

1. A method comprising:
controlling, by a controller, a first device for packet timing, including assigning a first packet start time to the first device based on the first clock; and
controlling, by the controller, a second device for packet timing, including assigning a second packet start time to the second device, wherein the second packet start time is based on the first clock and is offset in time from the first packet start time.

2. The method of claim 1, wherein a first packet associated with the first packet start time, and a second packet associated with the second packet start time, each comprises an advertising indication.

3. The method of claim 1, further comprising receiving, by the controller and via the second device, a connection request responsive to the first or second packet from a third device via the first device.

4. The method of claim 3, wherein the third device is a smartphone or a key fob.

5. The method of claim 1, wherein the first device comprises the controller.

6. The method of claim 1, wherein the second device comprises the controller.

7. The method of claim 1, wherein a vehicle comprises the first and second devices, and the controller.

8. The method of claim 7, wherein the first device and the second device are configured to transmit outward from the vehicle.

9. The method of claim 1, wherein the first packet includes a protocol data unit (PDU) according to a Bluetooth Low Energy (BLE) protocol.

10. The method of claim 1, wherein the first packet start time is offset from the second packet start time by an elapsed time equal to a time domain length of an advertisement packet plus two time domain lengths of an inter frame space (TIFS) plus a time domain length of a connection indication packet.

11. The method of claim 1, wherein a first packet associated with the first packet start time and a second packet associated with the second packet start time are part of a plurality of packets transmitted on a primary advertising channel.

12. The method of claim 11, further comprising:
controlling the first device for packet timing on one or more secondary advertising channels, including assigning a third packet start time to the first device and based on the first clock; and
controlling the second device for packet timing on the one or more secondary advertising channels, including assigning a fourth packet start time to the second device and based on the first clock.

13. The method of claim 12, wherein the third packet start time is offset from the fourth packet start time by an elapsed time equal to a time domain length of an auxiliary advertisement packet plus two time domain lengths of an inter frame space (TIFS) plus a time domain length of a connection request packet.

14. The method of claim 1, wherein the first device is associated with a first resolvable private address (RPA), and wherein the second device is associated with a second RPA, wherein the first RPA and the second RPA are configured to resolve to a same device address.

15. The method of claim 1, wherein controlling the first device and controlling the second device includes exchanging control signals between the controller and the first and second devices via a wired bus.

16. The method of claim 1, wherein controlling the first device and controlling the second device includes exchanging control signals between the controller and the first and second devices via a wireless medium.

17. The method of claim 1, further comprising:
controlling the controller for advertisement packet timing, including assigning a fifth packet start time to the controller based on the first clock.

18. The method of claim 1 further comprising:
receiving, by the controller, first quality metric data from the first device, wherein the first quality metric data refers to signal quality of a first packet addressed to the second device and as received by the first device; and
receiving second quality metric data from the second device, wherein the second quality metric data refers to signal quality of the first packet as received by the second device.

19. The method of claim 18, further comprising:
analyzing, by the controller, the first quality metric data and the second quality metric data; and
instructing the first device to connect to a connecting device based at least in part on the analyzing.

20. The method of claim 18, wherein the first quality metric data comprises first received signal strength indicator (RSSI) data, and the second quality metric data comprises second RSSI data, and wherein the method further comprises:
analyzing, by the controller, the first RSSI data in the second RSSI data, and
instructing either the first device or the second device to connect to a connecting device based on which one of the first device or the second device has a highest RSSI.

21. The method of claim 18, wherein the first quality metric data comprises first link quality indicator (LQI) data, and the second quality metric data comprises second LQI data, and wherein the method further comprises:
analyzing, by the controller, the first LQI data in the second LQI data, and
instructing either the first device or the second device to connect to a connecting device based on which one of the first device or the second device has a highest LQI.

22. The method of claim 1, wherein controlling the first device for packet timing and controlling the second device for packet timing includes assigning the first packet start time and the second packet start time to ensure advertisement packets of the first device avoid collision with advertisement packets of the second device.

23. The method of claim 1, further comprising:
synchronizing the first device and the second device with the controller according to a common timing of the first clock.
